(19) United States
(12) Patent Application Publication
(10) Pub. No.: US 2015/0244772 A1
(43) Pub. Date: Aug. 27, 2015

(54) FAST RENDERING OF CONTENT USING A MOBILE USER DEVICE

(71) Applicant: Triple IT B.V., Alkmaar (NL)

(72) Inventors: Schalk STALMAN, Alkmaar (NL); Michael PLEIN, Alkmaar (NL); Stef KAMPEN, Alkmaar (NL); Ernst TEGEL, Alkmaar (NL); Erik VAN SCHALKWIJK, Alkmaar (NL)

(21) Appl. No.: 14/188,152

(22) Filed: Feb. 24, 2014

(51) Int. Cl. H04L 29/08; H04L 29/06

(52) U.S. Cl. CPC H04L 67/10; H04L 67/42; H04L 67/02

(57) ABSTRACT

A user device including a client application (client) that enables rendering of content by a content rendering application (CRA). The client is configured for receiving user input indicating that a predefined portion of the content file is to be rendered, the portion starting at a specific time within the duration of the content file, sending to a server of the service provider an HTTP client request message requesting a playlist for the requested portion of the content file, providing to the CRA an instruction to request the playlist from the client, receiving from the server of the service provider an HTTP client response message comprising the requested playlist and storing the received playlist in a memory within the UD, receiving from the CRA an HTTP player request message requesting the playlist, and responding to the request by sending am HTTP player response message including the playlist obtained from the memory.

### FIELD OF THE INVENTION

The invention relates to rendering video content and, in particular, though not exclusively, to a method, a computer program product for using such method, a mobile user device, and a GUI for enabling fast rendering of video content using the mobile user device,.

Nowadays mobile handheld user devices such as smart phones or tablet computers provide a very effective means for viewing content, e.g. video content such as movies or music videos. FIG. 1A schematically depicts a typical system 100 involved in rendering content on a mobile user device. In particular, system 100 is a content streaming system for streaming segmented, content to clients in mobile user devices using HTTP live streaming protocol (HLS). In such an approach, a user of a mobile user device 102 provides an indication to the user device 102 that he/she wants to watch a particular movie, e.g. by means of a graphical user interface (GUI) 104 included within an application 106 of the user device 102. Upon receiving such an indication from the user, the application 106 provides a notification to a video player 108, which could also be included within; the user device 102, indicating that the user wants to watch that particular movie, which notification could be considered as a trigger for initializing rendering of video content (i.e., the movie requested by the user) by the video player 108.

The notification provided from the application 106 to the video player 108 contains, among other information, an address where the video player 108 could get playlist fires for that movie from. As is well-known in the field of video streaming, the term “playlist file”, also sometimes referred to as a “manifest file” refers to a file containing references to the segments of the (video) content to be distributed. These references indicate to the video player where the video player can obtain the actual segments of the content from. While the actual content is typically stored in and distributed from one or more content servers 110 (i.e. the references in the playlist files indicate memory locations within the content servers 110), the content servers 110 also sometimes referred to as a “content delivery network” or “CDN”, playlist files for the content are stored in and distributed from one or more servers of the service provides 112 (the servers of the service providers are hereafter referred to as simply “service providers”). It is, therefore, the address of the service provider 112 that is provided to the video player 108 by the application 106.

Although well-known in the field, playlist files are now described in more detail, starting with a single-bitrate content stream situation. Typically, a piece of video content stored in the content servers 110 is broken up into multiple segments of 3-10 seconds. This is shown in FIG. 1A with the content servers 110 storing a movie 114 broken up into segments 1, 2, 3, 4, . . . n. As also shown, each of the n segments is associated with a corresponding URL. For a single-bitrate streaming, the service provider 112 stores playlist files containing HTTP links with these URL addresses, such playlist files sometimes referred to as “main playlist files” or “main playlists”. Typically a single playlist file contains a few URLs, shown in FIG. 1A as a playlist file 116, within the service provider 112, storing three URLs for the first three segments of the movie 114. Thus, the service provider 112 stores also further playlist files for the movie 114 so that all of the n URLs for the n segments are accounted for (further playlist files not shown in FIG. 1A).

The case of multi-bitrate streaming is slightly different from that illustrated with the playlist 116 in that, in such a case, a playlist file such as the playlist file 116 contains not the actual URL addresses but references to available playlist files at the service provider 110 that are encoded using a particular stream quality, the latter playlist sometimes referred to as “child playlist files”. The child playlist files contain, in turn, the HTTP links with the URL addresses to the content segments in the content server. So, for multi-bitrate streaming, once the main playlist file is obtained from, the service provider, then child playlist flies still need to be obtained in order to get URL links to the actual content segments in the content server.

According to current state of the art, once the application 106 provided a notification to the video player 108 that the user of the device 102 would like to watch the movie 114, shown in FIG. 1A with an arrow 118, the video player 108 uses the address included within such a notification to contact the service provider 112 with a request for playlist files for the movie 114, the request shown in FIG. 1A with an arrow 120. The service provider 112 then responds to the video player 108 by providing the first playlist file 116 for the movie 114, as shown with an arrow 122. For the single-bitrate streaming, once the video player 108 received the first playlist file, it can start requesting the actual content from the content server 110 using the URLs provided in the playlist file, shown in FIG. 1A with an arrow 124. For the multiple-bitrate streaming, once the video player 108 received the first playlist file, it then requests child playlist files from the service provider 112 and only after receiving those, can the video player start requesting the actual content from the content server 110 using the URLs provided in the child playlist file.

As the segments 1, 2, 3, and so on are being downloaded to the user device 102, the video player 108 can start rendering their video on a display of the user device 102 so that the user can start watching the movie. As the user is watching the movie, communications similar to those illustrated with arrows 120-124 continue taking place (not shown in FIG. 1A) as the video player requests and receives subsequent playlist files for the movie 114 from the service provider 112 and uses the received URLs to request and receive subsequent segments of the movie from the content server 110. Moreover, requests and responses for the playlist files are typically repeated several times for the same playlist files (also not shown in FIG. 1A), in order to make sure that all of these files are reliably received at the video player 108 and in order to timely account for changes that the service provider may have done to the playlists, e.g. in view of the changes that the content server has done to the corresponding segments.

FIG. 1B provides an alternative schematic illustration indicating the timing of signalling involved in obtaining a playlist file (PF), as described in association with FIG. 1A. FIG. 1B also illustrates the video player 108 providing two repeated requests for the same playlist file PF, shown as “Request(1)” and “Request(2)”, and receiving two responses, shown as “Response(1)” and “Response(2)”, respectively.

One problem with an approach as illustrated in FIGS. 1A and 1B is that all the processing and signalling 120-124 associated with obtaining a playlist file with a reference containing the address in the content server for the very first segment of the content requested by the user takes up some time. This results in a noticeable and undesirable delay for the user before the requested content can be obtained at the user device and rendered by the video player (i.e. before the movie 114 actually starts playing), Usually for the subsequent segments the delay is not noticeable, provided sufficient bandwidth is available for the communications 120-124, because subsequent playlist files containing the URLs and subsequent segments of the movie 114 can be sequentially obtained at the user device while the user is watching the previous segments.

The problem of delay re-appears again and then becomes even more annoying to the user if, in the midst of watching the movie 114, the user wants to do something unexpected for the system such as e.g. go forward or backward in time in the movie, a situation sometimes referred to as “time-shifting”. In such a situation, once the user indicated to which point in time the user would like to go to in the movie being played (e.g. using the GUI 104), the application 106 again provides a notification to that effect to the video player 108 which is, again, a trigger for initializing rendering of video content starting from a particular point in time in the movie, similar to how it was done when the user initially indicated desire to watch that movie to begin with (in that case the point in time within the content was the earliest point in time of the requested movie, say t=0). As with the initial user request to watch a particular movie, at this point the user device 102 may again not be prepared for immediately rendering the requested content for the user because the user device first needs to obtain the playlist files containing the URL addresses of the content segments, then access the segments using the addresses, and only then start rendering. In particular, for the case of going forward in time, it could, be that the video player 108 has not yet received the playlist file containing the first URL for the requested movie further in time (say, for the segment (n−5) of the n segments of the movie 114) and therefore cannot immediately download and render that segment. For the case of going backward in time, it could he that the video player 108 may no longer possess or have access to the playlist file containing the first URL for the requested movie back in time as, due to the memory constraints of the user device 102, the downloaded playlist files and segments can only be stored at the device 102 for a limited time and are deleted once the segment has been played.

As the foregoing illustrates, there is a need in the art for improved methods and systems for fast rendering of video content using mobile user device, in particular when time-shifting is involved.

### SUMMARY OF THE INVENTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Functions described in this disclosure may be implemented as an algorithm executed by a microprocessor of a computer. Furthermore, aspects of the present invention may take the form of a computer program product embodied in one or more computer readable medium(s) having computer readable program code embodied, e.g., stored, thereon.

Any combination of one or more computer readable medium(s) may be utilized. The computer readable medium, may be a computer readable signal medium or a computer readable storage medium. A computer readable storage medium may be, for example, but not limited to, an electronic, magnetic, optical, electromagnetic, infrared, or semiconductor system, apparatus, ox device, or soy suitable combination of the foregoing. More specific examples (a non-exhaustive list) of the computer readable storage medium would include the following: an electrical connection having one or more wires,, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program, code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium, and that can communicate, propagate, or transport a program for use by or in connection with, an instruction execution system, apparatus, or device.

Program code embodied on a computer readable medium may be transmitted using any appropriate medium, including bat not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server, in the latter scenario, the remote computer may be connected to the user's computer through any type of network, including a local area network (LAN) or a wide area network (WAN), or the connection may be made to an external computer (for example, through the Internet using an internet Service Provider).

Aspects of the present invention are described below with reference to flowchart illustrations and/or block diagrams of methods, apparatus (systems), and computer program products according to embodiments of the invention. It will foe understood that each block of the flowchart illustrations and/or block diagrams, and combinations of blocks in the flowchart illustrations and/or block diagrams, can be implemented by computer program instructions. These computer program instructions may be provided to a processor, in particular a microprocessor or central processing unit (CPU), of a general purpose computer, special purpose computer, or other programmable data processing apparatus to produce a machine, such that the instructions, which execute via the processor of the computer, other programmable data processing apparatus, or other devices create means for implementing the functions/aces specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce aft article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted, in the blocks may occur cat of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform, the specified functions or acts, or combinations of special purpose hardware and computer instructions.

One of the goals of the embodiments of the present invention is to reduce or eliminate at least one of the drawbacks known in the prior art. In one aspect, the invention may relate to a method for enabling rendering of at least a portion of a segmented content file or a content stream, (e.g. a video stream) by a content rendering application (e.g. a video player) of a mobile user device (i.e., a portable electronic device). The user device comprises a client application comprising a GUI that, when displayed on a touch-sensitive display of the user device, allows the user device to receive user input. The method involves at least one processor, preferably at least one microprocessor, in the user device executing computer readable program code comprising steps of the client application receiving, via the GUI, a first user input indicating that a first portion of the content file is to be rendered by the content rendering application, the first portion starting at a first time within the duration of the content file, the client application sending to a server of a service provider, hereafter referred to as a “service provider”, a first HTTP client request message requesting a first playlist file for the first portion of the content file, and the client application providing to the content rendering application an instruction to request the first playlist file from the client application. The first playlist file contains one or more references to one or more respective (i.e., corresponding in a one-to-one correspondence) segments of the first portion of the content file, the one or more references enabling the content rendering application to access and render the one or more segments of the first portion of one content file. The method further includes steps of the client application receiving from the service provider a first HTTP client response message comprising the first playlist file, the client application receiving from the content rendering application a first HTTP player request message requesting the first playlist file, the client application storing the first playlist file received from the service provider in a memory within the user device, and, in response to receiving the first player request message, the client application providing to the content rendering application a first HTTP player response message comprising the first playlist file obtained from the memory within the user device, the first playlist file enabling the content rendering application to render the first portion of the content file.

As used herein, the term “playlist file” refers to a file or a data structure containing one or more references to one or more segments of a content file or stream stored in the content servers, which references enable the user device (in particular e.g. the content rendering application of the user device) to access (e.g. download and/or stream) the segments of the content, file from the content servers in order to render the segments on a display of the user device. In some embodiments, such references may include links to the actual segments as stored on the content servers, such as e.g. URL addresses (e.g. in case of single-bitrate streaming). In other embodiments, such references of a playlist file may include further references to data in the service provider or the content server that allows the user device to eventually access the segments of the content file from the content servers in order to render the segments on a display of the user device (e.g. in case of multi-bitrate streaming the references in a playlist file may contain further references for obtaining one or more of child playlist file(s) from the service provider, which child playlists, in turn, contain the links to the actual segments as stored in the content servers, such as e.g. URL addresses.

As also used herein, since embodiments of the present invention relate in particular to streaming of content using HTTP live streaming protocol (HLS), the expressions related to requests and responses for the playlist file are understood to he HTTP requests and HTTP responses, e.g. the expressions related to client request and respond messages imply HTTP client request and respond messages, while the expressions related to player request and respond messages imply HTTP player request and respond messages.

Embodiments of the present, invention are based on the recognition that having a client application (in particular, a playlist handler described herein) that is configured to immediately request a playlist file from the service provider as soon as the client application has received user input to that effect gives the user device a head start on ensuring that the content rendering application has the playlist file for the requested content, in particular for the first segment of the requested content, and can promptly access and render the segment. By the time the content rendering application is informed of the user desire to have a particular piece of content starting at a particular point in time rendered (i.e., by the time the content rendering application is initialized) and by the time the content rendering application figures out which entity it should contact to get the necessary playlist file (according to embodiments of the present invention that entity is the client application), the client application has already requested the necessary playlist file from the service provider and may have even received and stored it locally on the user device. If, when the client application requests a playlist file from the server of the service provider, the client application acts as a requesting “client” and the service provider acts as a responding “server”, she role of the client application changes once it has obtained the playlist file. At that point, the client application becomes a “server” providing playlist files to the “client” of the content rendering: application requesting such files.

The time it takes to exchange communications between an entity within a user device (e.g. a content rendering application or a client application) and a service provider is longer than the time it takes to exchange communications between two entities within the user device or at least within two entities within a local network of the user device because, for the former, communications take place over wide access network (WAN) and are subject to larger delays, while, for the latter, communications take place over the local area network (LAN). Embodiments of the present invention ensure that the content rendering application can access the playlist files from within the local network, which playlist files were already requested from the service provider before the content rendering application even became aware and processed the user input requesting rendering of content. The client application according to embodiments of the present invention, in particular the play List handler of the client application, described below, uses caching mechanisms in order to eliminate unnecessary slower calls to the service provider and replace the return call by a faster call directly from the cache layer of the user device. In this manner, the time in which the content rendering application obtains the playlist file necessary for rendering the requested content, as measured e.g. from the moment the user provided the user input requesting that content, is shortened compared to the prior art described in the background section where first the client application had to inform the video player about user's request, then the video player had to process information received from, the client application, and only after that would the video player request the playlist file from, the service provider. Consequently, the delay between the time that the user indicates the desire to have particular content rendered and the time that the content rendering application can actually render that content on a display for the user is shortened compared to the prior art.

In an embodiment, the processor in the user device may be configured to execute computer readable program code further comprising steps of the client application receiving from the content rendering application a second player request message for the first playlist file, and, in response to receiving the second player request message, the client application providing to the content rendering application a second player response message comprising the first playlist file obtained from the memory within the user device. This embodiment benefits from the advantages described above in that a content rendering application configured to send repeated requests for the same playlist file can be provided with such a file very fast because the file can be obtained from the local, memory of the user device, i.e. within the LAN of the user device and the content rendering application.

In an embodiment, the first playlist file received from the service provider may be stored in the memory for a predetermined time period and the processor in the user device may be configured to execute computer readable program code further comprising step the client application, deleting the first playlist file from the memory after the predetermined, time period has expired. This embodiment provides the advantage that the limited memory resources of the user device are not wasted storing playlist files which may no longer be needed for rendering the video content by the content rendering application.

In an embodiment, the step of the client application providing to the content rendering application the instruction to request the first playlist file from the client application may be performed after than or simultaneously with (i.e., not earlier than) sending the first client request message. This embodiment allows further speeding up the process of providing the content rendering application with the playlist file because by the time the content rendering application is informed of the user's request for the first portion of the content file, the playlist file has already been requested from the service provider.

In an embodiment, the first user input may include information indicative of a stream quality which e.g. specifies titrate of the stream (e, g. high density (HD) stream, standard density (SD) stream, or low density (LD) stream) for the first portion of the content file, where the stream quality may be selected by the user via the GUI. In such an embodiment, the first client request may specify that the first playlist file is to be provided for the first portion of the content file in the selected streaming quality, preferably the first playlist file is provided that only relates to the first portion of the content file that is in the selected streaming quality. This embodiment provides the advantage that bandwidth and processing resource of the user device may be preserved by only receiving the playlist file and, therefore, only rendering the content file in the quality specifically prescribed by the user.

In an embodiment, the processor in the user device may be configured to execute computer readable program code further comprising steps of the client application receiving, via the GUI, a second input indicating that a second portion of the content file is to be rendered by the content rendering application, the second portion starting at a second time within the duration of the content file, the second time being different from the first time, the client application sending to the service provider a second client request message requesting a second playlist file for the second portion of the content file, the client application receiving from, the service provider a second client response message comprising the second playlist file, the client application receiving from, the content rendering application a second player request message from the content rendering application for the second playlist file, the client application storing the second playlist file received from the service provider in the memory, and, in response to receiving the second player request message, the client application providing to the content rendering application a second player response message comprising the second playlist file obtained from, the memory within the user device, the second playlist file enabling the content rendering application to render the second portion of the content file. Similar to the first playlist, the second playlist file contains one or more references to one or more respective (i.e., corresponding in a one-to-one correspondence) segments of the second portion of the content file, the one or more references enabling the content rendering application to access and render the one or more segments of the second portion of the content file. This embodiment provides the advantage that in particular during time-shifting, the content rendering application can also be provided with the correct playlist file in a manner that is faster compared, to that described in the background section.

According to another aspect of the present invention, a second method is disclosed. The second, method is a computer-implemented method for a client application of a mobile user device or a portable electronic device to enable rendering of at least a portion of a segmented content file by a content rendering application of the device is disclosed. The device comprises a touch-sensitive display, a memory, and at least one processor, preferably a microprocessor. The second method includes steps of detecting a first movement of a physical object on or near the touch-sensitive display indicating that a first portion of the content file is to be rendered by the content rendering application, the first portion starting at a first time within the duration of the content file and, in response to detecting the first movement, triggering the processor to execute computer readable program code comprising steps of seeding a first client request message to a service provider requesting a first playlist file for the first portion of the content file, providing an instruction to the content rendering application to request the first playlist file from the client application, receiving a first client response message from the service provider comprising the first playlist file, receiving from the content rendering application a first player request message requesting the first playlist file, storing the first playlist file received from the service provider in the memory, and, in response to receiving the first player request message, providing to the content rendering application a first player response message comprising the first playlist file obtained from the memory, the first playlist file enabling the content rendering application to render the first portion of the content file. The second method may also, optionally, trigger the processor to execute computer readable program code comprising other steps described, above for the first method.

In an embodiment, the second method may further include detecting a second movement of the physical object on or near the touch-sensitive display indicating that a second portion of the content file is to be rendered by the content rendering application, the second portion starting at a second time within the duration of the content file, the second time being different from the first time, and, in response to detecting the second movement, triggering the processor to execute computer readable program code comprising steps of sending to the service provider a second client request message requesting a second playlist file for the second portion of the content file, receiving from the service provider a second, client response message comprising the second playlist file, receiving from the content rendering application a second player request message from the content rendering application, for the second playlist file, storing the second playlist file received from the service provider in the memory, and, in response to receiving the second player request message, providing to the content rendering application a second player response message comprising the second playlist file obtained from the memory, the second playlist file enabling the content rendering application to render the second, portion, of the content file.

In an embodiment, the second method may further comprise displaying on the touch-sensitive display a timeline of the content file, where the processor is triggered to execute the computer readable program code in response to detecting the second movement when the second movement corresponds to a predefined gesture relative to the displayed timeline, in one further embodiment, such a predefined gesture relative to the displayed timeline may comprise a horizontal swipe gesture, which would be intuitive for the user desiring to time-shift to a different point within the content being rendered.

In an embodiment of the second method, the predefined gesture relative to the displayed timeline may comprise a movement along a predefined path displayed on the touch-sensitive display.

In another embodiment, the second method may further comprise displaying an icon on the touch-sensitive display and transforming the icon in accordance with the first movement, wherein the icon is a graphical, interactive user-interface object with which a user interacts in order to enable the device to render at least a portion of the content file.

In various embodiments of the second method, the physical object may comprise a stylus or a finger.

According to another aspect of the present invention, a mobile user device or a portable electronic device is also disclosed. The device is communicatively connected to a content rendering application for rendering at least a portion of a content file (in some embodiments the content rendering application may be included, within the device itself, while in other embodiments the content rendering application may be included within other devices that are preferably in the same LAN with the first device)- The device includes a client application comprising a GUI, at least one processor, preferably a microprocessor, a touch-sensitive display for displaying the GUI and receiving user input via the GUI, a communication module, and a computer-readable memory having computer-readable program code embodied therewith. The touch-sensitive display, the communication module, and the computer-readable memory are communicatively connected to the processor. Responsive to executing the computer-readable program code, the processor is configured to perform executable operations for the methods described herein.

According to another aspect, embodiments of the present invention may further relate to a computer program product comprising software code portions configured for being stored in a memory of a computer and configured for, when run on a processor of the computer, executing the method steps as described above.

According to yet another aspect, embodiments of the present invention may further relate to a non-transitory computer-readable storage medium storing instructions (e.g. in the form of software code portions) configured for, when executed on a processor of a computer, performing the method steps as described above.

The invention will be further illustrated with reference to the attached drawings, which schematically will show embodiments according to the invention. It will, be understood that the invention is not in any way restricted to these specific embodiments.

### BRIEF DESCRIPTION OF THE DRAWINGS

FIG. 1A schematically depicts a typical system involved in rendering content on a mobile user device according to prior art;

FIG. 1B provides an alternative schematic illustration for signalling involved in obtaining a playlist file as described, in association with FIG. 1A;

FIG. 2 schematically depicts a system for carrying out methods enabling rendering of content on a content rendering device according to various embodiment of the present application;

FIG. 3 is a block diagram illustrating an exemplary data processing system that may be used as or in a user device implementing various embodiments of the present invention;

FIG. 4 schematically illustrates an exemplary messaging diagram for enabling rendering of content by a content rendering application, according to one embodiment of the present invention; and

FIGS. 5-9 illustrate examples of GUIs of the client application as displayed on the user device, according to various embodiments of the present invention.

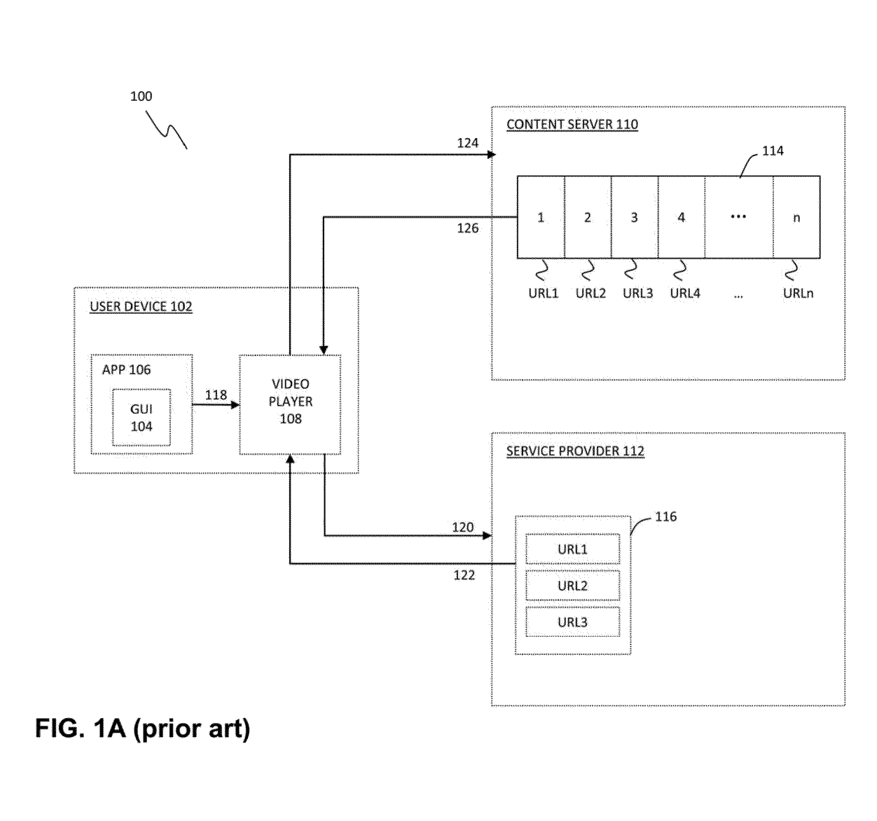

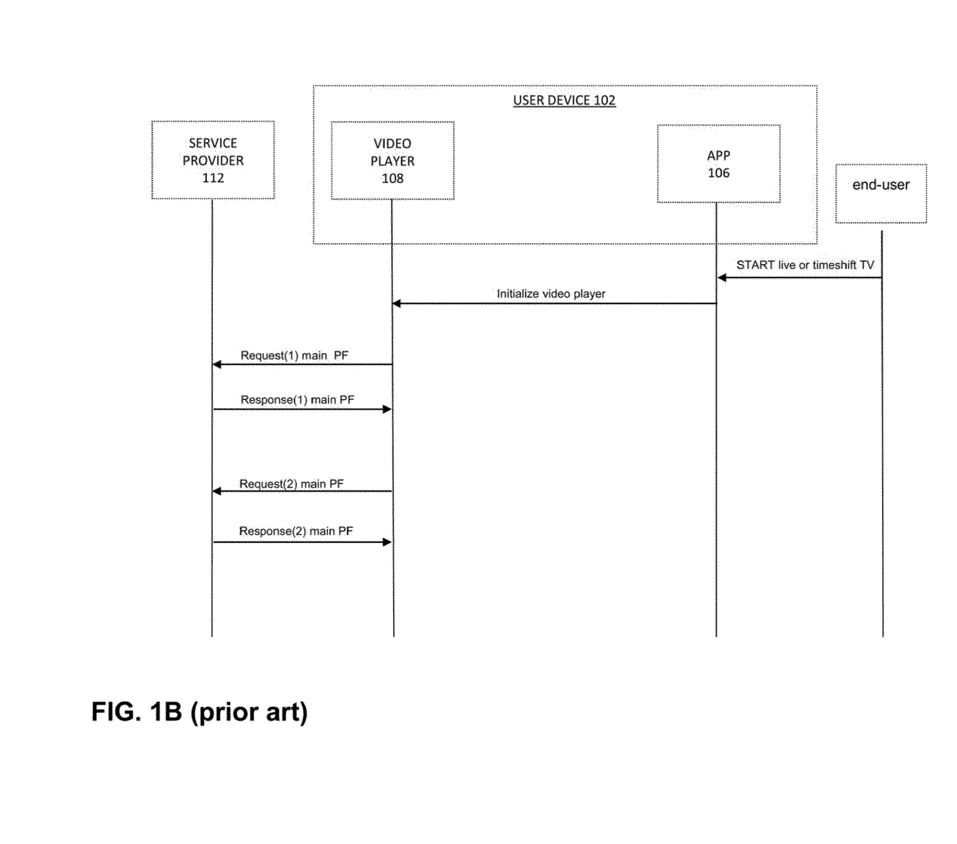

### DETAILED DESCRIPTION

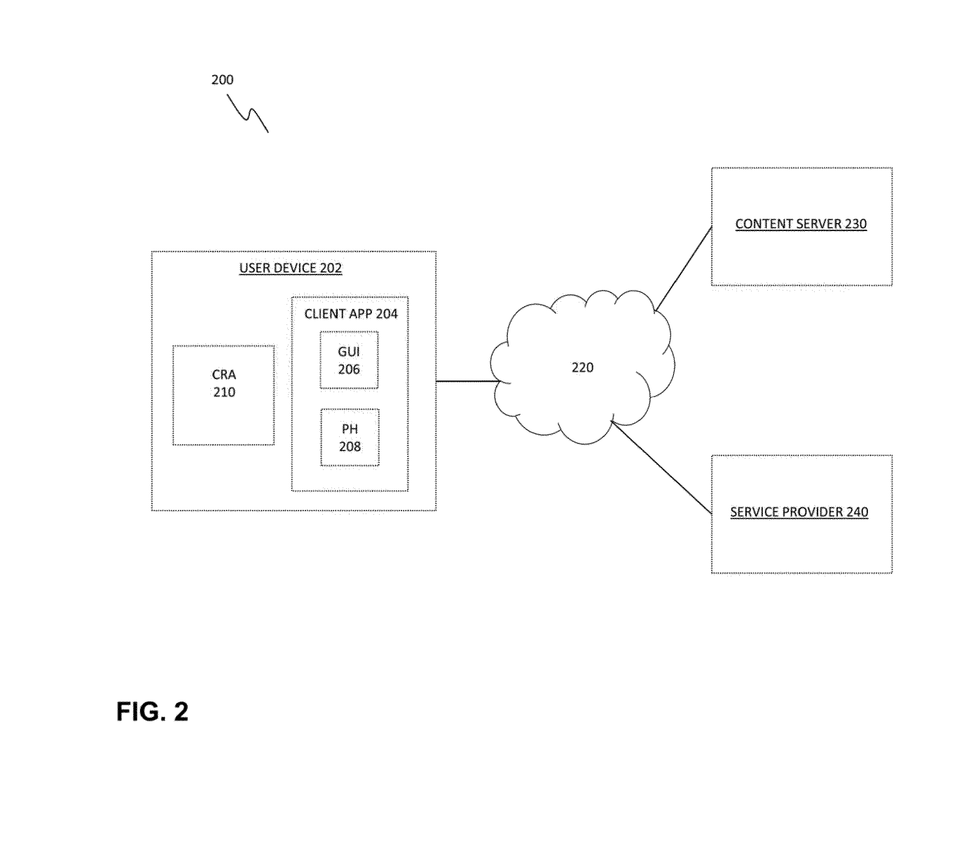

FIG. 2 schematically depicts a system 200 for carrying out methods according to various embodiment of the present application. As shown, the system 200 includes a mobile user device 202, which could be any kind of a portable electronic device such as e.g. a smart phone, an electronic tablet or the like, connected over a communications network 220 to one or more content servers 230 and/or one or more service providers 240. The communication between the user device and the server as well as between the user device and the service provider may be realized on the basis of the HTTP(S) protocol thereby avoiding problems with firewalls. The one or more content servers 230 and the one or more service providers 240 are similar to the content servers 110 and the service providers 112, respectively, described in the background section. Although typically the user device 202 and the content servers 230 and the service providers would be connected via a wide area network (WAN), in various embodiments the network 220 could include any type of network, such as e.g. WAN, local area network (LAN), or the connection of the network 220 may be realized via an external computer (for example, through the Internet using an Internet Service Provider). The network 220 could include two separate networks—one for connecting the user device 202 to the content servers and another one for connecting the user device to the service providers.

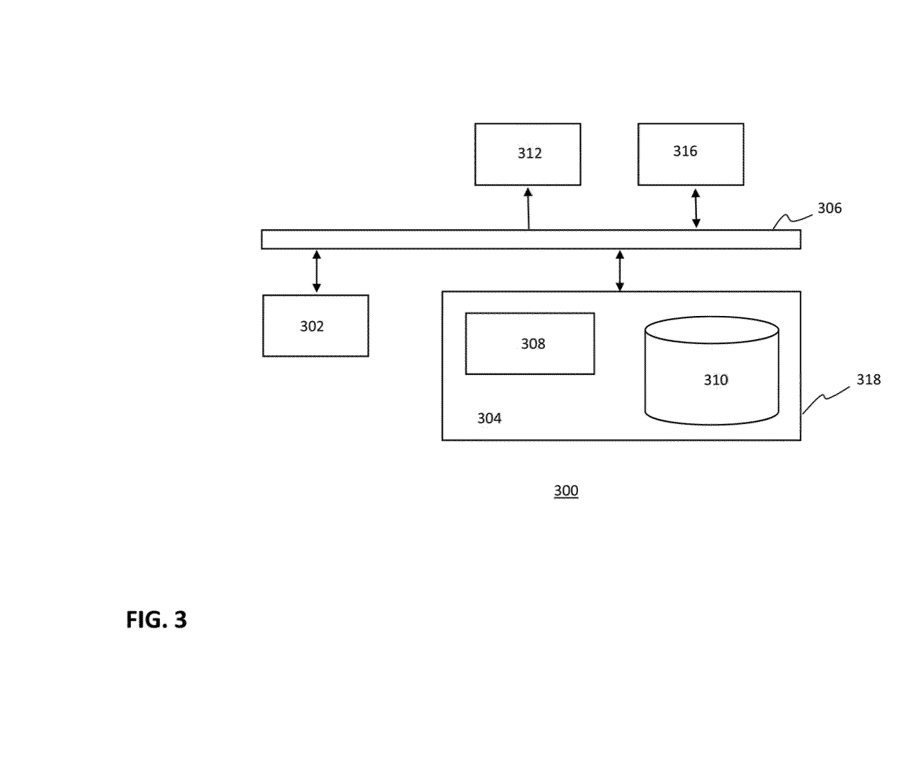

The user device 202 may comprise a client application 204 comprising a GUI 206 for receiving user input, and a playlist handler 208 for carrying out at least some steps of the methods described herein. Typically, the client application 204 would be a third-party video application that can be downloaded and installed on the user device 202 as a mobile TV streaming app and, therefore, typically, the client application 204, the GUI 206, and the playlist handler 208 would be implemented in software. However, in various embodiments any on these elements could foe implemented in software, hardware, or a combination of both. Further, the user device 202 may be or may include a data processing system such as the one shown, in FIG. 3 and is described below and may include some or all of the components of the data processing device of FIG. 3.

The user device 202 shown in FIG. 2 is shown to also include a content rendering application (CRA) 210 which is an HTTP adaptive streaming (HAS) client such as a HSL client. The CRA 210 could be any of the commercially available content rendering applications, e.g. a video player such as e.g. QuickTime, Windows Media Flayer, JWPlayer, Android video player, or VLC Mediaplayer. While FIG. 2 and the subsequent messaging diagrams herein illustrate the CRA 210 to be included within the user device 202, in other embodiments the CRA 210 could be a device or implemented on a device that is separate from, the user device 202. As long as the CRA. 210 and the user device 202 with the client application 204 can exchange communications within the same LAN, the advantages of the present inventions described herein may be realized.

While in FIG. 2, the playlist handler is illustrated to be a part of the client application 204, in other embodiments the protocol handler can also be implemented as a separate entity that e.g. could be part of the content rendering application and/or the HSL client.

FIG. 3 is a block diagram, illustrating an exemplary data processing system 300 that may be used to implement embodiments of the present disclosure. Data processing system 300 may include at least one processor 302 coupled to memory elements 304 through a system bus 306. As such, the data processing system may store program cede within memory elements 304, such as e.g. program code for implementing the functionality of one or more of the client application 204, the GUI 206, and the playlist handier 208. Further, processor 302 may execute the program code accessed from memory elements 304 via system bus 306. In one aspect, data processing system may foe implemented as a computer that is suitable for storing and/or executing program code, it should be appreciated, however, that data processing system 300 may be implemented in the form of any system including a processor and memory that is capable of performing the functions described within this specification.

Memory elements 304 may include one or more physical memory devices such as, for example, local memory 308 and one or more bulk storage devices 310, Local memory may refer to random access memory or other non-persistent memory device(s) generally used during actual execution of the program code, A bulk, storage device may be implemented as a hard drive or other persistent data storage device. The processing system 300 may also include one or more cache memories (not shown) that provide temporary storage of at least some program, code in order to reduce the number of times program code must be retrieved from bulk, storage device 310 during execution. The temporary storage may also be used for temporary storing playlist file(s) within the user device 202.

Input/output (I/O) devices depicted as input/output devices 312 optionally can be coupled to the data processing system. Examples of input device may include, but are not limited to, for example, a keyboard, a pointing device such as a mouse, or the like. Examples of output device may include, but are not limited to, for example, a monitor or display, speakers, or the like. Examples of a single device that may be considered an input and an output device at the same time include e.g. a touch-sensitive display or the like. Input/output devices may be coupled to data processing system either directly or through intervening I/O controllers,

A network adapter 316 may also be coupled to data processing system to enable it to become coupled to other systems, computer systems, remote network devices, and/or remote storage devices through intervening private or public networks. The network adapter may comprise a data receiver for receiving data that is transmitted by said systems, devices and/or networks to said data and a data transmitter for transmitting data to said systems, devices and/or networks, Modems, cable modems, and Ethernet cards are examples of different types of network adapter that may be used with data processing system.

As pictured in FIG. 3, memory elements 304 may store an application 318, such as e.g. the client application, the GUI, or the content rendering application described herein. It should be appreciated that data processing system 300 may further execute an operating system (not shown) that can facilitate execution of the application. Application, being implemented in the form of executable program code, can be executed by data processing system 300, e.g., by processor 302, which is preferably a microprocessor. Responsive to executing application, data processing system may be configured to perform one or more operations to be described herein in further detail.

In one aspect, the data processing system 300 may represent a client data, processing system. In that case, application 318 may represent, a client application that, when executed, configures data, processing system 300 to perform the various functions described herein with reference to a “client”. Examples of a client can include, but are not limited to, a personal computer, a portable computer, a mobile phone, or the like.

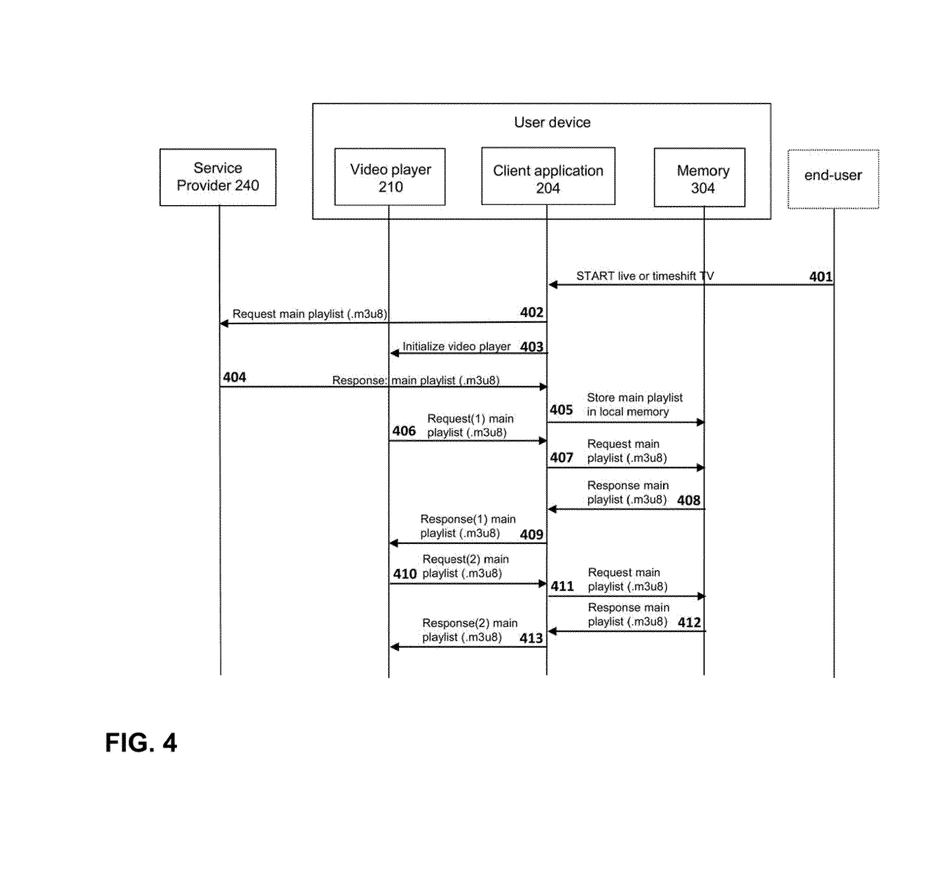

FIG. 4 schematically illustrates an. exemplary messaging diagram for enabling rendering of content by the content rendering application 210, according to one embodiment of the present invention. The messaging diagram illustrates messages between an end-user (i.e. a user of the user device, which is typically, but not necessarily a human being), a service provider 240, and a user device 202 including the content rendering application 210, here shown as a video player 210, a client application 210, and memory, such as e.g. the memory 304 described in association with FIG. 3. Elements in FIG. 4 that are shown to have element numbers illustrated and described in association with earlier FIGS. are intended to illustrate the same elements or specific examples of the elements described in. those earlier figures. The messaging diagram will be described for an example of the content to he rendered being a movie and the content rendering application being a video player. Of course the same discussions apply to any other types of content files or streams.

As shown, in step 401 the user provides his input indicating that he would like to watch a particular movie starting from, a particular point in time within the duration of the movie. This may be done by means of a GUI displayed for the user on the display of the user device 202. Consider, for example, that the user indicated that he would like to watch a movie “Forrest Gump” starting from time zero (i.e., starting from the beginning of the movie).

The step 401 where the GUI may detect the user input indicating user's desire to have a particular piece of content rendered, starting from a particular point in time within the timeline of the content may be considered as a trigger for the client application, in particular the playlist handler 208 of the client application, to perform, steps 402-413 that result in the video player obtaining the playlist(s) necessary for rendering the requested content, which, in turn, allows the video player to render the requested content.

Once the client application 204 receives such user input via the GUI 206, it proceeds to, in step 402, request the main playlist for the movie “Forrest Gump” from the service provider 240, e.g. in a form of an HTTP(S) request. As described above, the first playlist will typically include references to the first few segments of the movie “Forrest Gump” that smart from the time within the timeline of the movie that the user indicated (in this example, time zero).

After or simultaneously with the step 402, the client application 204 will perform step 403 where the client application provides a notification to the video player 210 informing the video player of the user's desire to watch the movie “Forrest Gump” starting from time zero. The notification of step 403 will include an indication to the video player 210 as to where the video player should obtain the playlist from. This is done so that conventional video players can still foe used with the embodiments of the present invention. Such conventional video players are configured to receive a notification from a client application on the user device providing them with an indication where they should request the playlist, but in prior art that indication has always pointed to a particular service provider that the user device is bound to. In step 403, however, the notification to the video player will indicate that the video player 210 should, obtain the playlist from the client application 204 within the user device. Such an indication, may be provided e.g. by including a URL link and/or an IP address of the client application within the user device. Thus, the video player is re-directed to use the client application as the “server” providing playlist files instead of using the service provider for that purpose. The step 403 where the video player is informed of the user's desire to have some content rendered and where the video player is provided with an indication about the location of the playlists is sometimes referred to “initialization” of the video player 403.

In step 404, which could actually take place before step 403 especially if step 403 was drone later than step 402, the client application 204 receives a response from the service provider 240, the response containing the playlist file that the client application requested in step 402. The client application then, proceeds, in step 405, to store the received playlist within the local memory of the user device, such, as e.g. the memory 304, possibly cache memory. In an embodiment, the client application may be configured to store the received playlist only for a specific predetermined amount of time and after that the client application can provide an instruction to delete the stored playlist from the local memory. The amount of time during which the playlist is stored may depend e.g. on the length of the segments and or the end user ‘time-shifting’ (requesting) another part of the video and can be any amount of time that is provides an adequate compromise between the ability to render the content segments referenced in the playlist file and the need to preserve limited memory resources of the user device.

In this manner, by the time the video player 210 has processed the initialization of step 403 and sends a request for the playlist for the first few segments of the movie “Forrest Gump” starting from time zero to the client application, shown with step 406, it is likely that the client application already received and stored that playlist locally within the user device. In response to receiving the request of step 406 from the video player, the client application obtains the requested playlist from the local memory, e.g. by issuing a request to the local memory and receiving a response with the playlist as shown with steps 407 and 408, respectively. The client application may then respond to the video player by providing the requested playlist, step 409. The video player 210 may then use the references within the obtained playlist to access the actual segments of the content and start rendering the segments on the display of the user device.

Since conventional video players are sometimes currently configured to request the same playlist multiple times using the address provided to them during their initialization, the video player 210 can also issue repeating requests for the same playlist, again using the address of the client application, this is shown with step 410. Steps 410-413 are performed in the same manner as steps 406-409 described above and, therefore, in the interests of brevity their description is not repeated here.

The method described above is applicable to both the single-bitrate streams as well as to the multi-bitrate streams. In case the content requested by the user is available in a multi-bitrate stream, the GUI of the client application 204 may provide the user with an option to select the desired stream quality. In such a case, the client application may detect which stream quality the user has selected as a part of receiving the user input in step 401. In such a case, in one embodiment, the client application could be configured to immediately request the playlist containing only references to the segments of the selected quality, in step 402, and therefore only obtain such playlists. However, if the client application is configured to work according to the currently existing protocols for obtaining playlists, then, in other embodiments, it will first request and obtain the main playlist containing further references to where a child playlist can be obtained and store it in the local-memory at least for the time such a playlist is processed by the client application, and then repeat steps 402 and 404 requesting and receiving the referenced child playlist from the service provider, and then repeat steps 405-409 for providing the received child playlist to the video player. The child playlist will then contain the references to the actual segments of “Forrest Gump” in the quality specified by the user.

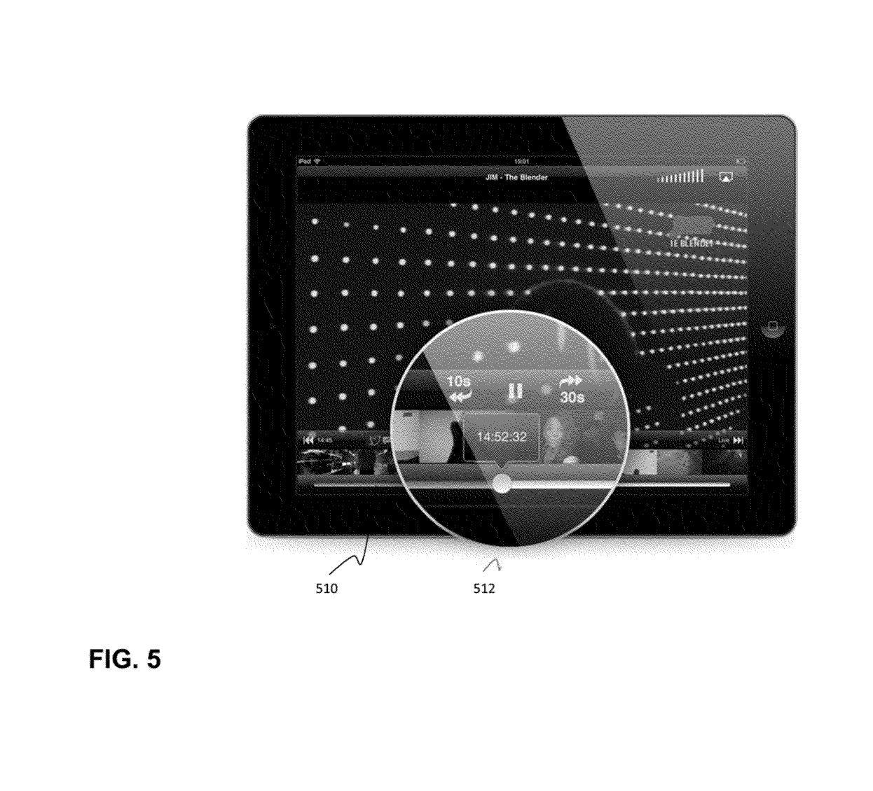

While the method described above was described with respect to the user starting to watch “Forrest Gump” from time zero, the same steps are performed if the user wants to watch the movie starting from any other time within the duration of the movie, and/or if the user starts watching the movie and then decides to jump backward or forward in the timeline of the movie (i.e., time-shifting). FIG. 5 illustrates an example of a GUI that could be used to enable the user to do time-shifting. The GUI of FIG. 5 depicts a timeline 510 and an icon 512. The icon 512 could be a graphical, interactive user-interface object with which the user interacts in order to enable to render the part of the content that the user wants to have rendered. For example, the GUI could be configured such that the user needs to perform a predetermined gesture, e.g. a horizontal swipe gesture, in order for the GUI to register and identify user's input and trigger the client application to perform the steps described, above for obtaining the necessary playlist (s). In an embodiment, the GUI could be configured to display on the touch-screen display of the user device a predefined path along which the gesture needs to be carried out.

If the user time-shifts to another point in time during watching of “Forrest Gump”, e.g. he can jump forward, or backward by, say, 5 minutes by using such a GUI, then steps 402-413 described above are repeated but now for the playlist corresponding to the segments starting from the new point in time indicated by the user. In the interests of brevity, these steps are not repeated here. The only difference may be that this time the client application may not need to provide to the video player 210 the indication that the video player is to request playlists from the client application because the video player may still have this indication from the first time it had to get playlists for this particular piece of content.

While the methods described herein may be applicable to any scenarios where content needs to be rendered upon user's request, they are particularly advantageous for streaming of segmented contented on the basis of an HTTP streaming protocol such as HLS while increasing the speed of starting an HTTP Live Streaming (HLS) in favor of the GUI and user experience. The HLS protocol contains a lot of requests necessary to determine what video segments are to be distributed to the user device. The speed of starting such a stream can be improved by building the playlist handler as described herein between the iOS media player and the service provider. In this manner, the end-user is provided with a far better video discovery experience (less than 1 second until the end-user is presented with the video content of his/her choice) within the client, application described herein than any other live video streaming application currently on the market.

In the following, additional, optional, features of the GUI 206 are described.

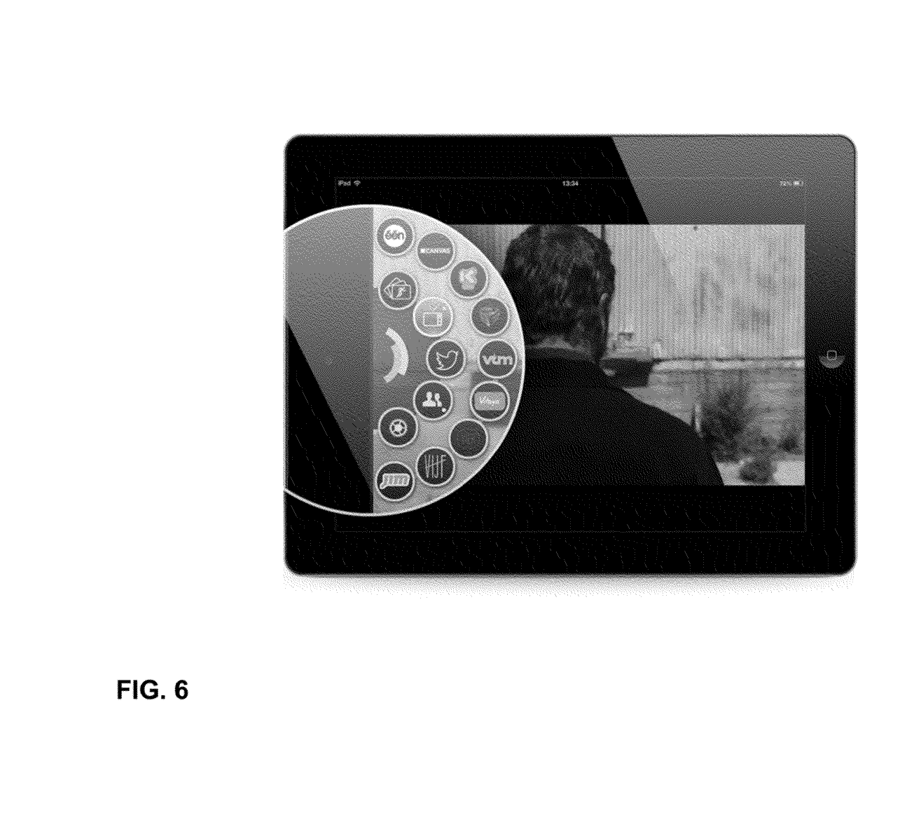

In an embodiment, the GUI could be configured to detect user input at such a location on the touch-screen display of the user device and according to such a predefined path that if requires/encourages the user to perform a specific predetermined gesture in that location on the touch-screen display in order to activate the client application to trigger the device to perform a certain action. The applicant of the present invention has realized that a swipe with a thumb either from left of the screen or from the right of the screen, is particularly advantageous because it allows the user to control the device while holding the user device, especially a tablet computer, in a normal way, with one hand on the left and the other on the right. Thus, in one embodiment, the GUI could be configured to detect user input as a predetermined gesture comprising a carved swipe as the one that can be made by swiping a thumb while holding the user device with all the other fingers at a predetermined location on the touch-screen display. In another embodiment, the GUI could be configured to detect user input as a predetermined gesture comprising two or more taps along a predetermined curved line as the one that can be made by swiping a thumb while holding the user device with all the other fingers at a predetermined location on the touch-screen display. In still other embodiments, the GUI could be configured to detect user input as a predetermined gesture comprising a combination of taps and swipes along such a line. In response to detecting such a user input, the GUI is configured to activate the device (i.e. transfer the user device from one state to another state of the device), e.g. to open a menu if the user has been, watching TV on the user device. The GUI could be further configured to detect user input by user interacting with graphical, interactive objects within the menu to control operation of the user device. Preferably, the menu is opened at such a location on the touch-screen display of the user device that all further interactions of the user with the menu can also be performed by user only using his thumb while holding the user device in a normal way. FIG. 6 illustrates an exemplary GUI displayed on a touch-screen display of a user device showing a menu that could be opened with a predefined swipe gesture of user's left thumb. Such a menu could provide quick access to channel switching functionality, scene selection (by thumbnails of the video), and the sharing feature.

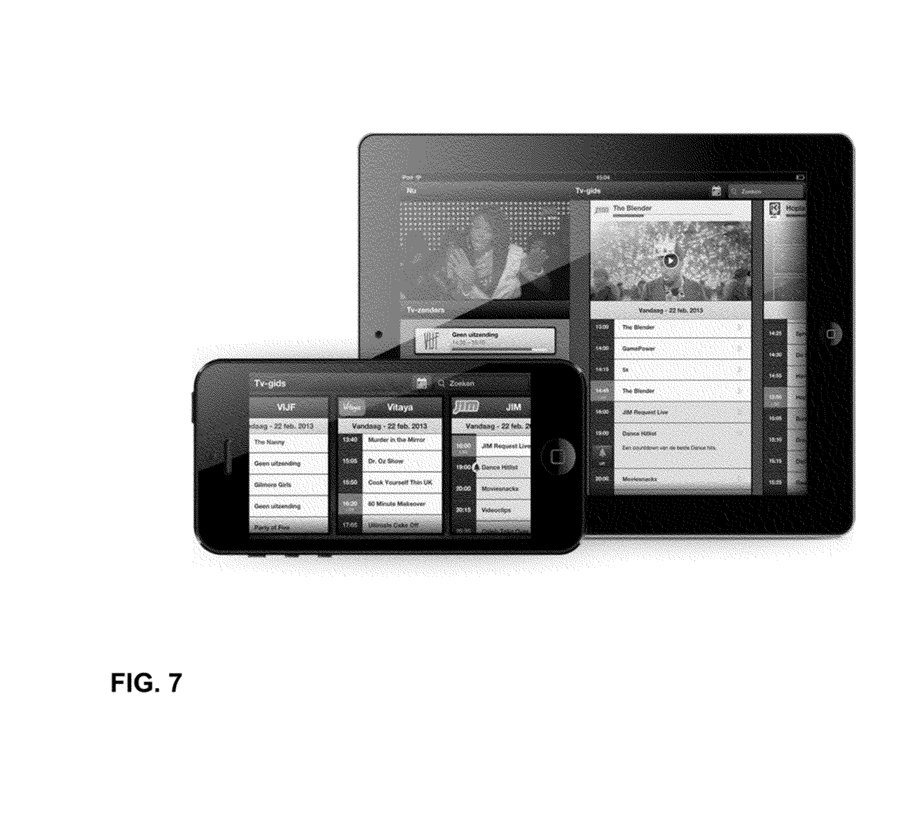

In an embodiment, the GUI 206 may be configured to allow the user to access an. electronic programming guide (EPG) by a swipe, e.g. from right to left, while still continuing watching the content that the user requested to have rendered, as described above. The GUI is configured to transform during the swipe while all content and information is displayed immediately, without loading indicators. The GUI is transformed by animating the gestures performed by the swipe in such a way that the user feels all information is displayed instantly. During the animation performed all content is immediately visible as it is retrieved in optimized form from the service provider its cache layer at start of the application. The significance of not having loading indicators, is that users are typically bothered by having to wait for an undetermined amount of time such a loading indicator would foe shown, while they understand an animation performed by themselves takes the time you need to perform the swipe gesture. In order to provide the end-user with such a smooth animated transition, the client application is configured to modify the EPG data and the EPG interface as provided to the user device 202 from an external source (e.g. as provided by the service provider and/or the content server) into as compressed format as possible for the specific dimensions of the touch-screen display of the user device. FIG. 7 illustrates a GUI showing such compressed EPG. To achieve this, in one embodiment the client application is configured to eliminate some of the information from the EPG provided to the user device, e.g. to remove all duplicated information by smaller information. For example, the client application may be configured to replace each icon and/or description of ‘The Voice’ program, with a unique number that refers to the text ‘The Voice’, in order to save characters and thereby data which needs to be downloaded and displayed by the client application. The GUI may then be configured to detect user input indicating user's selection of a particular piece of content within the EPG, starting at a particular point in time within the duration of that piece of content, for rendering via the content rendering application 210, and trigger the client application to perform steps of the methods described herein for rendering the selected piece of content on the user device.

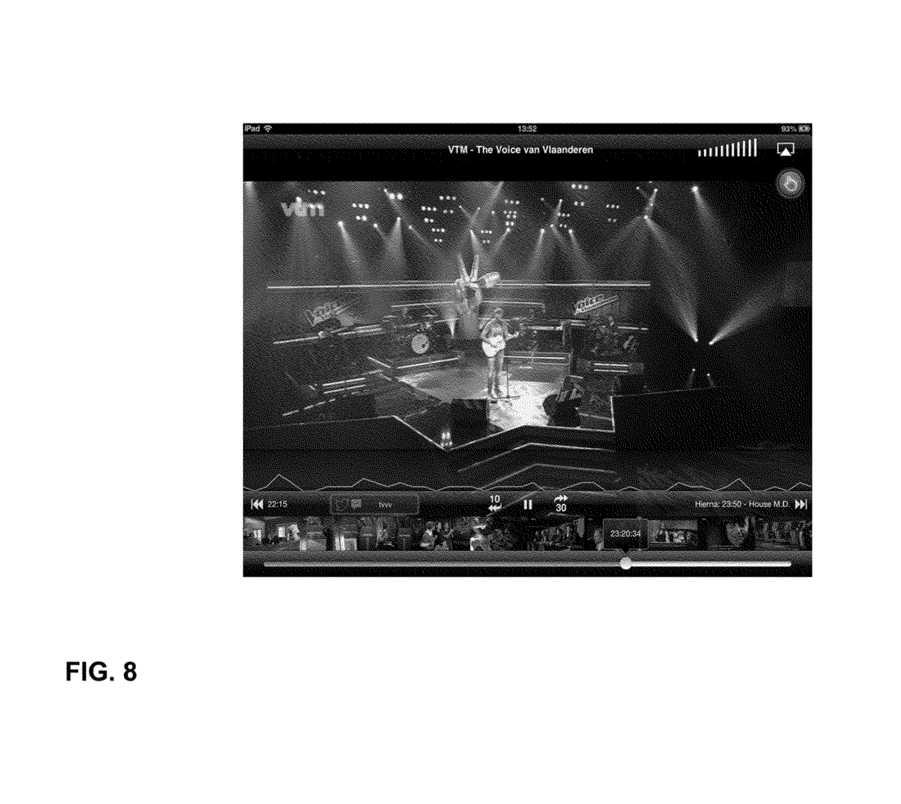

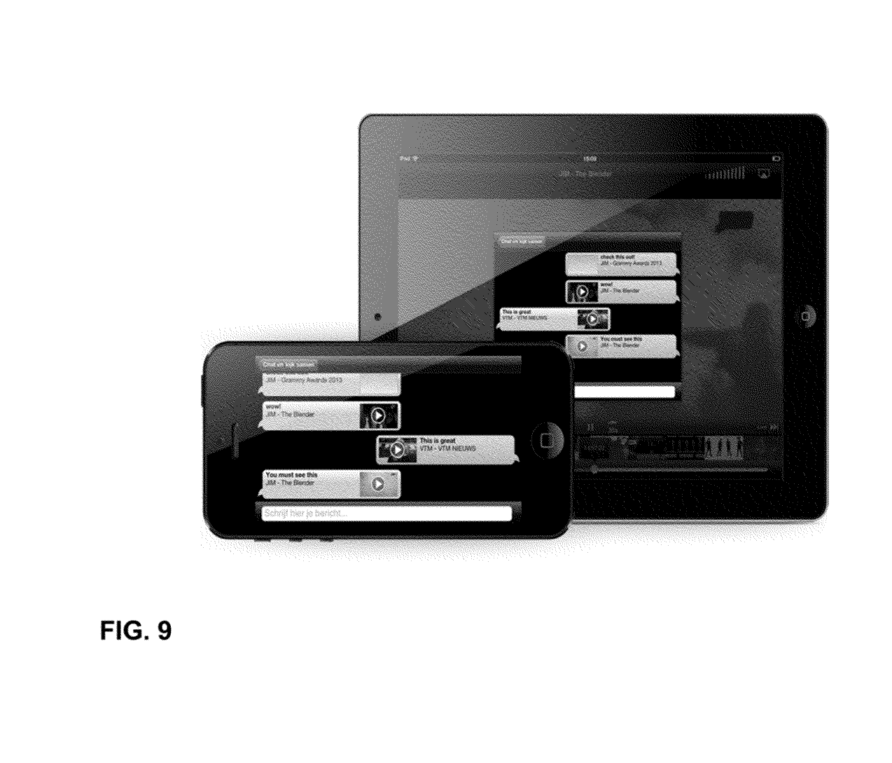

In yet another embodiment, the client application may be configured to enable the user to do content discovery by means of messages in one or more predetermined types of social media applications, such as e.g. Twitter. In such an embodiment, for a specific piece of content (e.g. a specific broadcast program), the client application is configured to count the number of Twitter messages containing a specific Twitter hash/tag (#) related to that broadcasted program, during the time of the original broadcast. The client application then instructs the GUI to display a timeline of the program and plot the counted number of Twitter messages at. their respective places along the timeline (the respective places determined by means of the hashtags referencing specific points in time within the duration of the broadcast program), An example of such a GUI is shown in FIG. 8. Displaying the GUI in this manner enables the end-user to determine on the scrub bar/time shift timeline at which specific times within a program events happened that were worth talking about on Twitter. The GUI may then, be configured to detect user input indicating user's selection of a particular place within the timeline for rendering via the content rendering application 210, thus triggering the client application to perform steps of the methods described herein.

In another embodiment, the client application may be configured to perform content discovery by recommendations from “friends” of the user of the user device on various social media applications, e.g. Facebook. In such an embodiment, the client application is configured to determine which social media applications are installed on the user device, then, for each social, media application, identify other users that are connected as “friends” to the user of the user device 202, and then, if those other users also have a client application corresponding to the application 204 installed on their user device, the client application 204 is configured to determine what content those other client applications are rendering at the moment and in which point in time in the duration of the content the rendering is. The client application may then be configured to provide notification to the user of the user device 202 about the content viewed by the friends of the user and display a GUI that allows the user to indicate his desire to watch the same content from the same point in time as one of his friends, at which point the client application performs the method steps described herein for rendering the requested content. In various further embodiments, the client application may foe configured to connect content discovery to other factors, such as e.g. GPS locations of friends as determined by the GPS devices within their user devices and/or the determination as to whether the “friend” is online, which information the client application could be configured to receive from the other user devices. Further, the client application could be configured to receive an indication, from one of the other user devices, that the user of that device wishes to share a particular piece of content with the user of the device 202, and provide a GUI that allows the user of the user device 202 to render that piece of content, according to the methods described herein.

Various embodiments of the invention may be implemented as a program product for use with a computer system, where the program(s) of the program product define functions of the embodiments (including the methods described herein). In one embodiment, the program (s) can. be contained on a variety of non-transitory computer-readable storage media, where, as used herein, the expression “non-transitory computer readable storage media” comprises ail. computer-readable media, with the sole exception being a transitory, propagating signal. In another embodiment, the program(s) can foe contained on a variety of transitory computer-readable storage media. Illustrative computer-readable storage media include, but are not limited to: (i) non-writable storage media (e.g., read-only memory devices within a computer such as CD-ROM disks readable by a CD-ROM drive, ROM chips or any type of solid-state non-volatile semiconductor memory) on which information is permanently stored; and (ii) writable storage media (e.g., flash memory, floppy disks within a diskette drive or hard-disk drive or any type of solid-state random-access semiconductor memory) on which alterable information is stored. The computer program may be run on the one or more processors 302, described herein.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step pins function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will foe apparent to those of ordinary skill in the art without departing from the scope and spirit of the invention. The embodiment was chosen and described in order to best explain the principles of the invention and the practical application, and to enable others of ordinary skill in the arc to understand the invention for various embodiments with various modifications as are suited to the particular use contemplated.

1. A method for enabling rendering of at least a portion of a content file by a content rendering application of a mobile user device, the user device comprising a client application comprising a graphical user interface (GUI) for receiving user input, the method comprising at least one processor in the user device executing computer readable program code comprising steps of:
the client application receiving, via the GUI, a first user input indicating that a first portion of the content file is to be rendered by the content rendering application, the first portion starting at a first time within the duration of the content file,
the client application sending to a server of a service provider a first HTTP client request message requesting a first playlist file for the first portion of the content file, the client application providing to the content rendering application an instruction to request the first playlist file from the client application,
the client application receiving from the server of the service provider a first HTTP client response message comprising the first playlist file,
the client application storing the first playlist file received from the server of the service provider in a memory within the user device,
the client application receiving from the content rendering application a first HTTP player request message requesting the first playlist file, and
in response to receiving the first player request message, the client application providing to the content rendering application a first HTTP player response message comprising the first playlist file obtained from the memory within the user device, the first playlist file enabling the content rendering application to render the first portion of the content file.

2. The method according to claim 1, further comprising steps of:
the client application receiving from the content rendering application a second HTTP player request message for the first playlist file, and
in response to receiving the second player request message, the client application providing to the content rendering application a second HTTP player response message comprising the first playlist file obtained from the memory within the user device.

3. The method according to claim 1, wherein the first playlist file received from the server of the service provider is stored in the memory for a predetermined time period, the method further comprising:
the client application deleting the first playlist file from the memory after the predetermined time period has expired.

4. The method according to claim 1, wherein the step of the client application providing to the content rendering application the instruction to request the first playlist file from the client application is performed after than or simultaneously with sending the first client request message.

5. The method according to claim 1, wherein:
the first user input comprises information indicative of a stream quality for the first portion of the content file, the stream quality selected by the user via the GUI, and
the first client request specifies that the first playlist file is to be provided for the first portion of the content file in the selected streaming quality.

6. The method according to claim 1, further comprising:
the client application receiving, via the GUI, a second input indicating that a second portion of the content file is to be rendered by the content rendering application, the second portion starting at a second time within the duration of the content file, the second time being different from the first time,
the client application sending to the server of the service provider a second HTTP client request message requesting a second playlist file for the second portion of the content file,
the client application receiving from the server of the service provider a second HTTP client response message comprising the second playlist file,
the client application storing the second playlist file received from the server of the service provider in the memory,
the client application receiving from the content rendering application a second HTTP player request message from the content rendering application for the second playlist file, and
in response to receiving the second player request message, the client application providing to the content rendering application a second HTTP player response message comprising the second playlist file obtained from the memory within the user device, the second playlist file enabling the content rendering application to render the second portion of the content file.

7. A mobile user device communicatively connected to a content rendering application for rendering at least a portion of a content file, the user device comprising a client application comprising a graphical user interface (GUI), a processor, a touch-sensitive display for displaying the GUI and receiving user input via the GUI, a communication module, and a computer-readable memory having computer-readable program code embodied therewith,
wherein the touch-sensitive display, the communication module, and the computer-readable memory are communicatively connected to the processor and
wherein, responsive to executing the computer-readable program code, the processor is configured to perform executable operations for:
the client application receiving, via the GUI, a first user input indicating that a first portion of the content file is to be rendered by the content rendering application, the first portion starting at a first time within the duration of the content file,
the client application sending to a server of the service provider a first HTTP client request message requesting a first playlist file for the first portion of the content file,
the client application providing to the content rendering application an instruction to request the first playlist file from the client application,
the client application receiving from the server of the service provider a first HTTP client response message comprising the first playlist file,
the client application storing the first playlist file received from the server of the service provider in a memory within the user device,
the client application receiving from the content rendering application a first HTTP player request message requesting the first playlist file, and
in response to receiving the first player request message, the client application providing to the content rendering application a first HTTP player response message comprising the first playlist file obtained from the memory, the first playlist file enabling the content rendering application to render the first portion of the content file,

8. The user device according to claim 7, wherein the processor is further configured to perform executable operations for:
the client application receiving from the content rendering application a second HTTP player request message for the first playlist file, and
in response to receiving the second player request message, the client application providing to the content rendering application a second HTTP player response message comprising the first playlist file obtained from the memory within the user device.

9. The user device according to claim 7, wherein the first playlist file received from the server of the service provider is stored in the memory within the user device for a predetermined time period, and wherein the processor is further configured to perform executable operations for the client application deleting the first playlist file from the memory within the user device after the predetermined time period has expired.

10. The user device according to claim 7, wherein the instruction to the content rendering application to request the first playlist file from the client application is provided after than or simultaneously with sending the first client request message.

11. The user device according to claim 7, wherein:
the first user input comprises information indicative of a stream quality for the first portion of the content file, the stream quality selected by the user via the GUI, and
the first client request specifies that the first playlist file is to be provided for the first portion of the content file in the selected streaming quality.

12. The user device according to claim 7, wherein the processor is further configured to perform executable operations for: the client application receiving, via the GUI, a second input indicating that a second portion of the content file is to be rendered by the content rendering application, the second portion starting at a second time within the duration of the content file, the second time being different from the first time,
the client application sending to the server of the service provider a second HTTP client request message requesting a second playlist file for the second portion of the content file,
the client application receiving from the server of the service provider a second HTTP client response message comprising the second playlist file,
the client application storing the second playlist file received from the server of the service provider in the memory,
the client application receiving from the content rendering application a second HTTP player request message from the content rendering application for the second playlist file, and
in response to receiving the second player request message, the client application providing to the content rendering application a second HTTP player response message comprising the second playlist file obtained from the memory within the user device, the second playlist file enabling the content rendering application to render the second portion of the content file.

13. A computer-implemented method for a client application of a portable electronic device to enable rendering of at least a portion of a content file by a content rendering application of the portable electronic device, the portable electronic device comprising a touch-sensitive display, a memory, and a processor, the computer-implemented method comprising:
detecting a first movement of a physical object on or near the touch-sensitive display indicating that a first portion of the content file is to be rendered by the content rendering application, the first portion starting at a first time within the duration of the content file; and
in response to detecting the first movement, triggering the processor to execute computer readable program code comprising steps of:
sending a first HTTP client request message to a server of the service provider requesting a first playlist file for the first portion of the content file,
providing an instruction to the content rendering application to request the first playlist file from the client application,
receiving a first HTTP client response message from the server of the service provider comprising the first playlist file,
storing the first playlist file received from the server of the service provider in the memory,
receiving from the content rendering application a first HTTP player request message requesting the first playlist file, and
in response to receiving the first player request message, providing to the content rendering application a first HTTP player response message comprising the first playlist file obtained from the memory, the first playlist file enabling the content rendering application to render the first portion of the content file.

14. The computer-implemented method according to claim 13, further comprising:
detecting a second movement of the physical object on or near the touch-sensitive display indicating that a second portion of the content file is to be rendered by the content rendering application, the second portion starting at a second time within the duration of the content file, the second time being different from the first time; and
in response to detecting the second movement, triggering the processor to execute computer readable program code comprising steps of:
sending to the server of the service provider a second HTTP client request message requesting a second playlist file for the second portion of the content file,
receiving from the server of the service provider a second HTTP client response message comprising the second playlist file,
storing the second playlist file received from the server of the service provider in the memory,
receiving from the content rendering application a second HTTP player request message from the content rendering application for the second playlist file, and
in response to receiving the second player request message, providing to the content rendering application a second HTTP player response message comprising the second playlist file obtained from the memory, the second playlist file enabling the content rendering application to render the second portion of the content file.

15. The computer-implemented method according to claim 14, further comprising displaying on the touch-sensitive display a timeline of the content file, wherein the processor is triggered to execute the computer readable program code in response to detecting the second movement when the second movement corresponds to a predefined gesture relative to the displayed timeline.

16. The computer-implemented method according to claim 15, wherein the predefined gesture relative to the displayed timeline comprises a horizontal swipe gesture.

17. The computer-implemented method according to claim 15, wherein the predefined gesture relative to the displayed timeline comprises a movement along a predefined path displayed on the touch-sensitive display.

18. The computer-implemented method according to any claim 13, further comprising displaying an icon on the touch-sensitive display and transforming the icon in accordance with the first movement, wherein the icon is a graphical, interactive user-interface object with which a user interacts in order to enable the device to render at least the portion of the content file.

19. The computer-implemented method according to any claim 13, wherein the physical object comprises a stylus or a finger.

20. Non-transitory computer-readable storage medium storing software code portions configured for, when run on a computer, executing a method for enabling rendering of at least a portion of a content file by a content rendering application of a mobile user device, the user device comprising a client application comprising a graphical user interface (GUI) for receiving user input, the method comprising at least one processor in the user device executing computer readable program code comprising steps of:
the client application receiving, via the GUI, a first user input indicating that a first portion of the content file is to be rendered by the content rendering application, the first, portion starting at a first time within the duration of the content file,
the client application sending to a server of a service provider a first HTTP client request message requesting a first playlist file for the first portion of the content file,
the client application providing to the content rendering application an instruction to request the first playlist file from the client application,
the client application receiving from the server of the service provider a first HTTP client response message comprising the first playlist file,
the client application, storing the first playlist file received from the server of the service provider in a memory within the user device,
the client application receiving from the content rendering application a first HTTP player request message requesting the first playlist file, and
in response to receiving the first player request message, the client application, providing to the content rendering application a first HTTP player response message comprising the first playlist file obtained from the memory within the user device, the first playlist file enabling the content rendering application to render the first portion of the content file.
